(19) United States
(12) Patent Application Publication
(10) Pub. No.: US 2021/0268990 A1
(43) Pub. Date: Sep. 2, 2021

(54) CHILD CAR SEAT SAFETY SYSTEM

(71) Applicant: Casey Loel Dodson, Minden, LA (US)

(72) Inventor: Casey Loel Dodson, Minden, LA (US)

(21) Appl. No.: 17/323,663

(22) Filed: May 18, 2021

Related U.S. Application Data
(60) Provisional application No. 63/169,847, filed on Apr. 1, 2021.

(51) Int. Cl. B60R 22/48; B60K 37/02; B60Q 5/00; B60Q 1/50; B60N 2/00; E05B 77/54

(52) U.S. Cl. CPC B60R 22/48; B60K 37/02; B60Q 5/005; B60Q 1/50; B60K 2370/178; E05B 77/54; B60R 2022/4808; B60R 2022/4866; B60K 2370/12; B60N 2/002

(57) ABSTRACT

A safety system for a vehicle that can remind the driver of the vehicle about the presence of a child in the rear seat of the vehicle. The safety system can trigger the alarm if the rear doors of the vehicle are not opened within a predetermined duration after the opening of the driver-side door and the front seats are empty.

### FIELD OF INVENTION

The present invention is related to a child car seat safety system, and more particularly, the present invention relates to a seat belt safety system for automobiles that can trigger an alarm when a child is left behind in the car.

### BACKGROUND

No baby or child should ever be left in a vehicle, especially in a hot vehicle. However, even the most caring of human beings are sometimes forgetful. Children are often the victims of this forgetfulness and die strapped in car seats. Thus, a long-term desire is there for a safety system that can remind the driver about the presence of a child in the rear seat of the vehicle.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a seat belt of the vehicle having a belt sensor, according to an exemplary embodiment of the present invention.

FIG. 2 is a side view of the vehicle showing a seat sensor and door sensors, according to an exemplary embodiment of the present invention.

FIG. 3 is a block diagram showing an exemplary embodiment of the safety system, according to the present invention.

FIG. 4 shows the dashboard of the vehicle having a switch, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

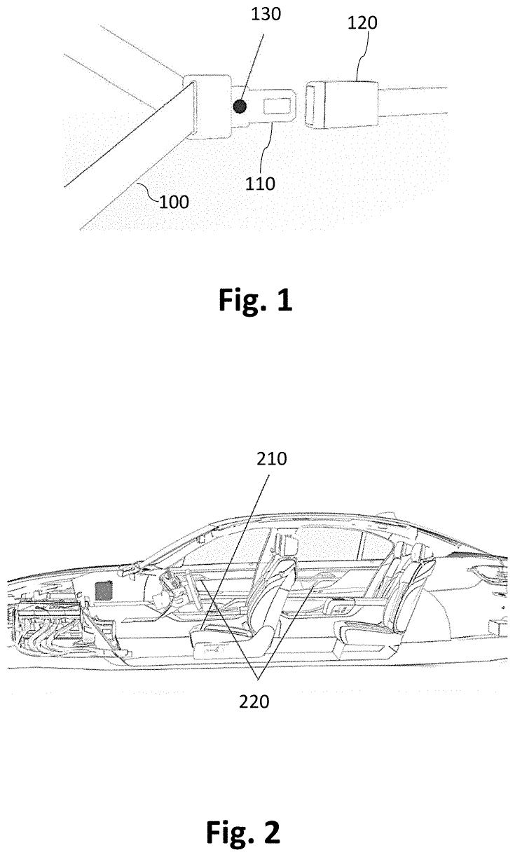

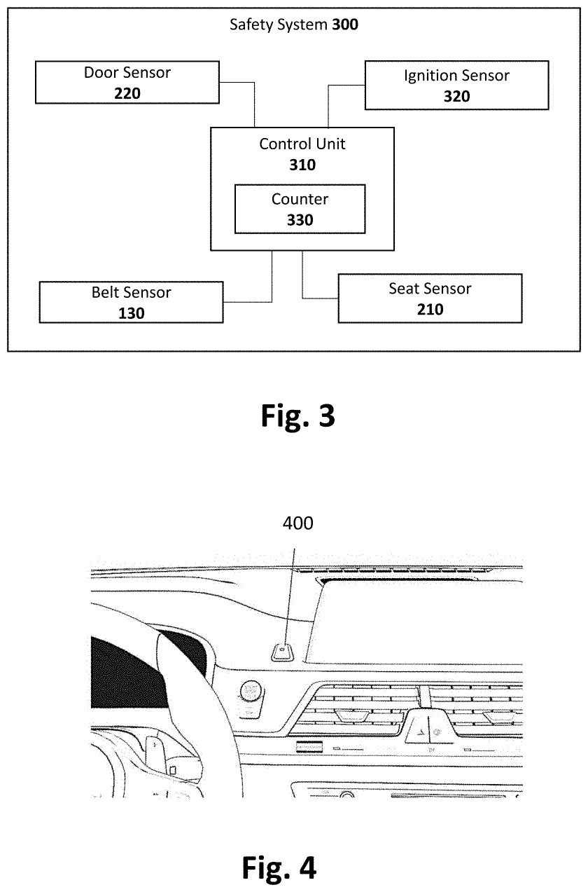

Disclosed is a safety system for vehicles that can remind the driver about the presence of a child in the rear seat of the vehicle. Referring to FIG. 1 which shows the seat belt 100 of a typical vehicle, such as a car. The seat belt 100 having a webbing and latch plate 110 that can be engaged to a buckle 120. The seat belt can be the seat belt of the vehicle's seat or a baby seat mounted on the rear seat of a vehicle. The latch plate, also known as the tongue, can be removably engaged to a buckle. A sensor can be coupled to the buckle or the latch plate that can detect the coupling of the latch plate to the buckle. FIG. 1 shows the latch plate 110 having the sensor 130. The sensor 130 can be wired or wirelessly connected to a circuitry of the safety system. One or all the seat belts of the rear seats of the vehicle can be provided with the disclosed sensor. In case, a child seat is mounted on the rear seat, the seatbelt of the child seat can be provided with the sensor. Engagement of the latch plate into the buckle activates the disclosed safety system.

The front seats of the vehicle can be provided with a weight/pressure sensor that can detect the presence of a person on the seat. Both the front seats can be provided with weight/pressure sensors. FIG. 2 shows the front seats of the vehicle having the seat sensor 210 which can be the weight sensor or the pressure sensor. The disclosed safety system 300 can include a control unit 310 which can be operably connected to the belt sensor 130 and the seat sensors 210. The disclosed safety system 300 can be installed in a vehicle at the time of manufacturing or retrofitted to a vehicle. Moreover, the disclosed safety system can be powered by the vehicle's electrical system, such as the battery of the vehicle. Alternatively, a separate rechargeable battery can also be provided for powering the disclosed safety system 300.

The disclosed control unit 310 can electrically connect to an electrical system of the vehicle for detecting an ignition state of the vehicle. Alternatively, the disclosed safety system 300 can also include an ignition sensor 320 that can detect the turning on of the ignition and turning off the ignition. The ignition sensor 320 can particularly detect the sequence of turning on of the ignition followed by the turning off the ignition. The disclosed safety system 300 can also include door sensors 220 that can detect the opening and closing of the doors of the vehicle. FIG. 2 shows the front and rear doors of the vehicle having the door sensors 220. In one case, all the doors of the vehicle can have the door sensors 220. Alternatively, both the rear doors and the driver-side door can have the door sensors 220.

The control unit 310 can be electrically connected to the vehicle's electrical system for triggering the lights and horn of the vehicle. The lights and horn of the vehicle can be used as an alarm to alert the persons nearby the vehicle. A switch can also be provided operably coupled to the control unit. Actuating the switch can turn off the alarm and reset the disclosed safety system. FIG. 4 shows a switch 400 provided on the dashboard of the vehicle that can be used to turn the alarm off. The switch can also be configured to turn the disclosed safety system on and off. For example, when not in use, the disclosed safety system can be turned off. The same switch can be used to turn the safety system on when a baby is or will be traveling in the vehicle. A switch can also be provided that can override the disclosed safety system for activating the safety system without the engagement of the seatbelt or any input from the belt sensor. Normally, the belt sensor activates the safety system, however, the safety system can also be manually activated independently of the belt sensor. This can be useful when a driver or a person in the front seat of the vehicle has kept something on the rear seat of the vehicle and wants to be reminded about the thing when leaving the vehicle.

In one embodiment, disclosed is a method of reminding a driver of the vehicle about the presence of a child in the rear seat of the vehicle. First, a child can be seated in the rear seat of the vehicle or the child seat mounted in the rear seat of the vehicle. The seat belt having the belt sensor can then be engaged resulting in activation of the disclosed safety system. While engaging the seat belt, the engine of the vehicle may or may not be running. If the engine is not running, the ignition of the vehicle can be turned on. The disclosed control unit through the ignition sensor can then detect the ignition being turned off. Upon detecting the ignition turned off, the control unit can then detect the status of the door sensor. The control unit can then receive a signal from the door sensors indicating that the driver-side door is opened. Receiving the signal from the door sensor triggers a counter. The control unit 310 can include a time counter 330. The value of the time counter can be preset, for example, the counter can be set at 7, 8, 9, or 10 seconds. A person or driver after moving out of the vehicle can open the rear gate for picking the child in the rear seat. The timing of the counter can be based on the time it generally takes for a person after opening the front gate to reach the rear gate and open it. In case, the rear door of the vehicle is not opened within the set time of the counter and both the front seats are empty, as detected by the seat sensors, the control unit can trigger the alarm. Opening the rear door within the set time of the counter deactivates the safety system. The control unit besides triggering the alarm may also unlock the rear door. This may allow any passerby to open the rear door of the vehicle and pick up the child in the rear seat. The alarm can be turned off by a switch provided in the vehicle, preferably on the dashboard of the vehicle. Opening the rear door may also turn the alarm off. The control unit may also provide an option to manually activate the safety system independent of the belt sensor.

The seat sensor can be a weight sensor or pressure sensor or any other sensor that can detect the presence of a person on the seat of the vehicle. In one case, the seat sensor can differentiate between a person and an object placed on the seat. This can prevent any false detection of the presence or absence of a person on the front seats.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for reminding presence of a child in a rear seat of a vehicle, the method comprising the steps of:
receiving a first signal, by a control unit of a safety system, from a belt sensor indicating engaging of a seat belt of a rear seat of a vehicle;
upon receiving the first signal, receiving a second signal, by the control unit, from a door sensor, indicating opening of a driver-side door of the vehicle;
upon receiving the second signal, activating a time counter, the time counter configured with a predetermined duration; and
triggering an alarm, by the control unit, when either of the rear doors of the vehicle is not opened within the predetermined duration after receiving the second signal and front seats of the vehicle are empty.

2. The method according to claim 1, wherein the method further comprises the step of:
upon triggering the alarm, receiving a fourth signal from the door sensors indicating opening either of the rear doors of the vehicle; and
upon receiving the fourth signal, turning the alarm off.

3. The method according to claim 1, wherein the method further comprises the step of:
upon triggering the alarm, receiving a fourth signal from actuation of a switch on a dashboard of the vehicle; and
upon receiving the fourth signal, turning the alarm off.

4. The method according to claim 1, wherein the alarm is a horn and lights of the vehicle.

5. The method according to claim 1, wherein the method further comprises the step of:
upon triggering the alarm, unlocking the rear doors of the vehicle by the control unit.

6. The method according to claim 1, wherein the method further comprises the steps of:
receiving a third signal from the seat sensors of the front seats of the vehicle, the third signal indicates an absence of a person on the front seats of the vehicle.

7. A safety system for a vehicle for reminding presence of a child in a rear seat of the vehicle, the safety system comprises:
a belt sensor configured to be installed in a seat belt of a rear seat of the vehicle, the belt sensor configured to detect engaging of the seat belt;
door sensors configured to be installed in rear doors and a driver side door of the vehicle, the door sensors configured to detect opening and closing of a door;
an ignition sensor configured to detect turning on of ignition of the vehicle;
seat sensors configured to be installed in front seats of the vehicle, the seat sensors configured to detect presence and absence of a person on a front seat of the front seats of the vehicle; and
a control unit operably coupled to the belt sensor, door sensors, seat sensors, and the ignition sensor, the control unit further comprising a time counter configured with a predetermined duration, the control unit is configured to:
receive a first signal from the ignition sensor indicating turning off the ignition,
receive a second signal from the door sensors indicating an opening of the front door of the vehicle,
activate the time counter upon receiving the second signal, and
trigger an alarm of the vehicle when either of the rear doors of the vehicle is not opened within the predetermined duration after receiving the second signal and the front seats of the vehicle are empty.

8. The safety system according to claim 7, wherein the predetermined duration is 7 seconds.

9. The safety system according to claim 7, wherein the sensors are weight sensors.

10. The safety system according to claim 7, wherein the control unit is further configured to:
upon triggering of the alarm, receive a third signal from the door sensors indicating an opening of either of the rear doors of the vehicle, and
upon receiving the third signal, turn the alarm off.

11. The safety system according to claim 7, wherein the control unit is further configured to:
upon triggering of the alarm, receive a third signal from actuation of a switch on a dashboard of the vehicle, and
upon receiving the third signal, turn the alarm off.

12. The safety system according to claim 7, wherein the alarm is a horn and lights of the vehicle.

13. The safety system according to claim 7, wherein the control unit is further configured to:
upon triggering the alarm, unlock the rear doors of the vehicle.
